(19) United States
(12) Patent Application Publication
(10) Pub. No.: US 2010/0185722 A1
(43) Pub. Date: Jul. 22, 2010

(54) Centralized ecommerce sales data distribution system and service

(76) Inventors: Gwyn Jones, Limassol (CY); Sebastien Coursol, Methuen, MA (US)

Correspondence Address: LOUIS VENTRE, JR, 2483 OAKTON HILLS DRIVE, OAKTON, VA, 22124-1530, US

(21) Appl. No.: 12/357,527

(22) Filed: Jan. 22, 2009

(51) Int. Cl. G06F 15/173

(52) U.S. Cl. 709/203

(57) ABSTRACT

A device and method is disclosed enabling centralized electronic distribution of a listing of an item for sale to numerous ecommerce web sites having disparate meta data requirements for their listings. Steps include engaging a plurality of ecommerce web sites to participate; contracting with an owner of an item to distribute sales meta data on the item to the web sites; creating a master electronic content file of sales meta data specific to the item and comprising the composite of the sales meta data required by all the web sites; storing the master electronic content file on a server; deriving a subset of sales meta data for each of the web sites; and, transferring each subset from the server to the respective web site for display. The system of the invention is in computer readable memory encoded with software that enables the steps of the method of the invention.

### TECHNICAL FIELD

In the field of electronic shopping, a system and method for improving the ability of an enterprise to practice, administer, or manage delivery of a listing of goods or services for sale to a plurality of purchaser-accessed ecommerce websites.

### BACKGROUND ART

The present invention is not practiced or taught in the prior art. Some of the steps serving differing purposes have similarities, but none discloses all of the steps uniquely serving the function of the present invention.

For example, U.S. Pat. No. 7,299,202 (the '202 patent) discloses for an intelligent product catalog system that provides for electronic creation, management and viewing of product information using a multimedia display system. The '202 patent teaches holding meta data on products on a server, automatic and dynamic reconfiguring the meta data, and a scheme system for product categorization. The present invention is not a product catalog system, but rather is in part a means for pushing product or service descriptive data (meta data) to diverse ecommerce web sites.

Another example is U.S. Pat. No. 6,938,005 (the '005 patent), which discloses a method for digital content distribution using a manifest that is created to represent a created work in electronic form. The '005 patent teaches a system for uniform electronic packaging of digital content independent of content type, along with automated distribution of digital content to desired recipients. The '005 patent instructs on the benefit of creating meta data to describe a product and selective editing or use of the meta data by a recipient. The present invention is different in that it creates a tailored meta data file for each ecommerce web site from a master file such that a tailored file meets the needs of a corresponding ecommerce web site. The tailored file is then pushed to the ecommerce web site for display.

Another example is United States Patent Application 20080004992 (the '992 application) for a federated marketplace that provides a context-based environment for consumers to purchase products and services directly from an Internet-based search engine results page, without the need to navigate to the sponsoring merchant's Web site. The '992 application in essence describes a means to instantly create an ecommerce web site based on search results. In support of that, the '992 application teaches provision of a central repository for the meta data that is accessed from a search engine results page. It further involves cataloguing goods or services on a server for access from the search engine results page, employs a product classification system on the server, and enables immediate download of content from the server. The present invention is different in that the meta data is not accessed through a search engine results page. Rather configured meta data is pushed to multiple ecommerce sites for display thereon by action originating from the server side.

### SUMMARY OF INVENTION

A centralized electronic distribution system and method aids in listing an item for sale at numerous ecommerce web sites, each potentially having different meta data requirements for its listings.

The method involves engaging a channel comprising a plurality of ecommerce web sites selling a particular category of goods or services to participate; contracting with an owner of an item to distribute sales meta data on the item to the channel; creating a master electronic content file of sales meta data specific to the item and comprising the composite of the sales meta data required by the ecommerce web sites in the channel; storing the master electronic content file on a server; deriving a subset of sales meta data for each of a plurality of ecommerce web sites in the channel; and, transferring each subset from the server to the respective ecommerce web site in the channel for which it was derived for display on the web site. The master electronic content file may also comprise a category descriptor of the item and information identifying the owner.

Supplementary steps involve confirming the owner's authority to advertise with the plurality of ecommerce web sites within the channel; adding other information to the master electronic content file, such as authorization for the server to act on the owner's behalf with the channel; storing electronic documents that are for sale on the server and enabling their download subsequent to a purchase; logging in to an ecommerce web site in the channel; capturing data concerning a purchaser of the item from the ecommerce web site; communicating the data to the owner; aggregating purchaser information; converting the aggregated data to a graphical representation displaying the geographical distribution of purchasers; and, sending the graphical representation to the owner.

The system of the invention is in computer readable memory encoded with software that enables the steps of the method of the invention.

### Technical Problem

In the physical world, products which are created by manufacturers and are shipped to distributors who warehouse the products until they can be shipped to stores where the products can be purchased by the final consumer. In other words, there is an indirect supply chain of one or more middlemen, namely distributors, between the manufacturer and the seller. For example, goods will originate at a manufacturer, then move to a distributor, then be sent to a store and finally be purchased by a buyer.

In the Internet world, there has been disintermediation, the elimination of the middleman between the manufacturer and the store. The web is considered almost exclusively a direct marketing channel, where the manufacturer, who may also be the owner and seller, offers his products directly through his own or someone else's virtual store (an ecommerce web site supporting product selection and payment). This constitutes a direct supply chain from the manufacturer to an ecommerce store where the buyer is an Internet user accessing the web site. No distributor between the manufacturer and the ecommerce web site is needed or involved.

There is an unrecognized business and marketing problem in the field stemming from the growing success of the Internet as a sales vehicle. That problem stems from numerous successful ecommerce sites hosting goods of numerous competitors in any single category of goods. So, if a manufacturer wants to increase sales of a product, the manufacturer is best served when his product is sold on the largest number of ecommerce sites available. However, each ecommerce site typically has a unique set of meta data requirements for its listings, requirements for compensation and other negotiated terms associated with a listing, and unique physical requirements, such as server access for electronic products, image size, image quality, etc. This diversity in requirements is a barrier to the manufacturers listing goods or services on the plethora of ecommerce sites. These unique requirements greatly increase the complexity for any single manufacturer to address in attempting to list goods or services on a large number of ecommerce sites.

### Solution to Problem

The present invention solves this unrecognized problem in the ecommerce industry by providing a system and method to greatly improve efficiency in reaching the largest number of ecommerce sites by re-intermediation, or re-introduction of a middleman, offering unique capability to quickly and easily meet ecommerce site requirements. This is accomplished by creating a master meta data file for each item, then significantly changing the meta data file (that is product marketing data) to meet the individual requirements of each ecommerce web site, modifying display images to satisfy each site's requirements, then distributing the meta data to the ecommerce site, having a server for storing or interacting with the manufacturer's server for electronic distribution of software or other electronic products, and having pre-set arrangements with the ecommerce web sites for compensation for sales and for any other requirements.

### Advantageous Effects of Invention

The invention promotes commerce and trade by providing a means and method for greatly simplifying engaging numerous ecommerce websites in displaying and selling items from owners. Items may be any product or service, including for example products that are commodities, those that are entirely electronic content, such as software, a photo, an ebook, a blog, a music file, a video file, and the full panoply of services that may be engaged by a buyer.

### BRIEF DESCRIPTION OF DRAWINGS

The drawings show preferred embodiments of the invention and the reference numbers in the drawings are used consistently throughout. New reference numbers in FIG. 2 are given the 200 series numbers. Similarly, new reference numbers in each succeeding drawing are given a corresponding series number beginning with the figure number.

FIG. 1 is a block diagram representing a preferred method of the invention.

FIG. 2 is a block diagram representing a preferred system of the invention.

### DESCRIPTION OF EMBODIMENTS

In the following description, reference is made to the accompanying drawings, which form a part hereof and which illustrate several embodiments of the present invention. The drawings and the preferred embodiments of the invention are presented with the understanding that the present invention is susceptible of embodiments in many different forms and, therefore, other embodiments may be utilized and structural, and operational changes may be made, without departing from the scope of the present invention. In particular, procedural steps in the invention as claimed and shown in the figures may be performed in any order that accomplishes the results described herein.

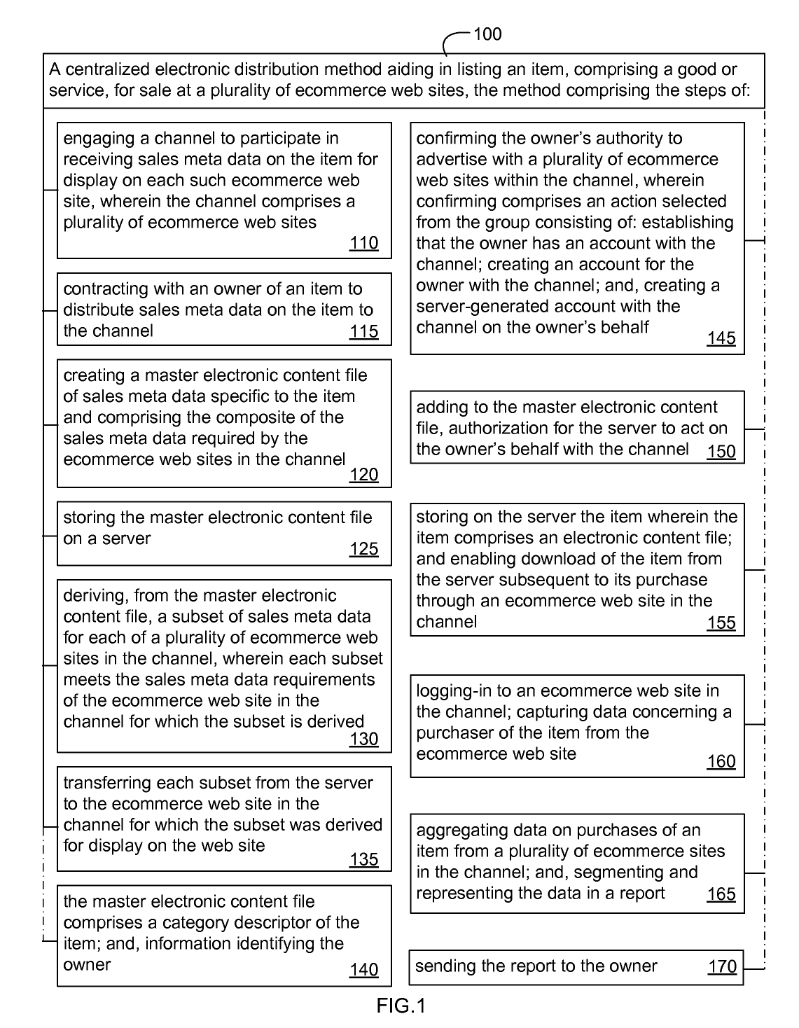

FIG. 1 illustrates several preferred embodiments of the method of the invention. Solid connecting lines indicate necessary steps and dashed lines indicate optional steps. The top box (100) indicates that the method is a centralized electronic distribution method aiding in listing an item, comprising a good or service, for sale at a plurality of ecommerce web sites, the method comprising a variety of steps. The steps implement the centralized electronic distribution of sales advertising data to ecommerce web sites, each of which may have a unique set of requirements to list an item, which may be a product or service, for sale. Thus, preferred methods aid in listing an item, comprising a good or service, for sale at a plurality of ecommerce web sites and they aid in accomplishing an actual sale of that item.

As used herein, “sales advertising data” is used interchangeably with the terms “meta data” and “sales meta data.” These terms are intended to broadly include any data or information describing or supporting the sale of the item. The meta data is structured electronic data, so it is a form of Electronic Data Interchange.

The ecommerce web sites are preferably organized in a “channel” or classification according to a logical taxonomy of ecommerce web sites that sell a particular category of goods or services. Organization of ecommerce web sites in channels enables prompt selection of like sellers for any particular item, and promotes efficient transmission of relevant meta data to them.

FIG. 1 shows that a preferred method includes a step of engaging a channel to participate in receiving sales meta data on the item for display on each such ecommerce web site, wherein the channel comprises a plurality of ecommerce web sites (110). Engaging includes satisfying any and all pre-conditions and requirements to enable ecommerce web sites to engage in or participate in the channel, accept transmissions of meta data on a particular item or category of item, and enable purchasers to buy the item. This may include such things as the precise formatting of meta data that the ecommerce web site will accept; whether or not seller authorization with the ecommerce web site is needed or whether or not the ecommerce web site will accept authorization from the business engaging the channel, the precise nature of compensation to the ecommerce web site for listing and selling the item; the means and method of receiving payment from the owner for a sale, authority for the ecommerce web site to sell the item directly, the details for conveying a purchaser's payment for an item; purchaser guarantees provided by the owner of the item; and any other detail associated with a sale transaction related to the item. For each item, there may be multiple channels relevant to list and sell the item.

FIG. 1 shows that a preferred method includes a step of contracting with an owner of an item to distribute sales meta data on the item to the channel (115). The “owner” of an item would typically be a manufacturer of the item or a provider of service. However, the term “owner” is intended to be broadly construed as a lawful seller of the item, regardless of legal title to the item. Thus, the owner may also be someone involved in the chain of sale of an item, or an end purchaser seeking resale of the item. The term “sales meta data” includes any and all information needed to describe the listing and implement a sale of the item through some or all of the ecommerce web sites in at least one channel. For example, sales meta data may include such data as a link to the owner's web site and other details related to the listing.

FIG. 1 shows that a preferred method includes a step of creating a master electronic content file of sales meta data specific to the item and comprising the aggregate or composite of the sales meta data required by the ecommerce web sites in the channel (120). Amassing the gross meta data that may be required or allowed by the ecommerce web sites in the channel allows the file to serve as the source of the meta data that will be extracted and sent to the individual ecommerce web site. For example, besides text, the meta data may include graphics, such as thumbnails of a product or service, or links to those graphics, one or more keywords or category descriptors of the item; information identifying the owner, and authorization for the server to act on the owner's behalf with any or all of the ecommerce web sites in the channel.

FIG. 1 shows that a preferred method includes a step of storing the master electronic content file on a server (125). Once created, the master electronic content file is stored on the computer or server to be later operated on by software on the server. The method may be implemented as a Virtualization Service, where the implementer of the method of the invention does not own a real, physical computer or server, but instead negotiates for storage space and server capabilities as demand requires. This is sometimes referred to as “cloud computing.” So, while this Virtualization Service has one or more real servers with computer readable memories, such as hard drives, the implementer of the method will not know which one is being used, and preferably could be using more than one server. Thus, the scope of the invention encompasses use of a virtual server in the “cloud.”

FIG. 1 shows that a preferred method optionally includes a step of storing on the server the item wherein the item comprises an electronic content file; and enabling download of the item from the server subsequent to its purchase through an ecommerce web site in the channel (155). This step comprises an optional additional service provided to the owner of the item to expedite delivery to the purchaser of an electronic content file, such as software, a photo, an ebook, a blog, music, video, etc.

FIG. 1 shows that a preferred method includes a step of deriving, from the master electronic content file, a subset of sales meta data for each of a plurality of ecommerce web sites in the channel, wherein each subset meets the sales meta data requirements of the ecommerce web site in the channel for which the subset is derived (130). Thus, to implement this method, one must derive a subset of sales meta data from the master electronic content file for each of a plurality of ecommerce web sites in the channel.

Ideally, a subset would be derived for all of the ecommerce web sites in the channel, but the invention contemplates that one or more of those may be excluded by the owner or excluded for some other operational reason. Thus, a subset is required only for a plurality of those ecommerce web sites in the channel. Each of the subsets derived would meet the sales meta data requirements of at least one ecommerce web site in the channel, so that a respective subset could be later sent to the ecommerce web site that requires that meta data for a listing. For example, should a particular ecommerce web site require a graphic in a particular format, size, color mode, watermark, dots per inch or image quality, then this step would act upon the image available to derive the required image.

FIG. 1 shows that a preferred method includes a step of transferring each subset from the server to the ecommerce web site in the channel for which the subset was derived for display on the web site (135). This step typically involves an electronic transfer via the Internet of each subset from the server to each of the ecommerce web sites for which the subset was derived. It may include implementing security such as logging in to an ecommerce web site in the channel. Thus, transferring implies all the necessary security protocols needed to accomplish this task.

FIG. 1 shows that a preferred method includes an optional step of confirming the owner's authority to advertise with a plurality of ecommerce web sites within the channel, wherein confirming comprises an action selected from the group consisting of: establishing that the owner has an account with the channel; creating an account for the owner with the channel; and, creating a server-generated account with the channel on the owner's behalf (145). Confirming the owner's authority to advertise with any ecommerce web site will typically depend on the agreement for engaging the ecommerce web site in the channel. For example, generic authority for any and all owners may be present and so no additional authority may be needed. On the other hand, an ecommerce web site in the channel may desire to have the owner sign an agreement with them and this would require additional action on the part of the owner that would be flagged in this step.

FIG. 1 shows that a preferred method includes an optional step of logging-in to an ecommerce web site in the channel; capturing data concerning a purchaser of the item from the ecommerce web site; and, communicating the data to the owner (160). This step would depend on the authorities agreed to when the ecommerce web site was included in a channel through the engaging step described above.

FIG. 1 shows that a preferred method includes a reporting function implemented with optional steps aggregating data on purchases of an item from a plurality of ecommerce sites in the channel; and, segmenting and representing the data in a report (165). These optional steps provide reporting information accessible or deliverable to the owner on the gross sales of an item, preferably from most if not all of the ecommerce web sites in the channel. An owner may log-in to the server and access a report, may use the system to specify parameters for desired reports, or a further optional step is sending the report to the owner (170), which might be accomplished via email or other desired delivery method.

The reporting function is advantageous because it eliminates an owner's need to log-in to each of the ecommerce web sites in the channel to try an assemble information detailing how well the seller is doing overall, which site is doing the best, and which items are doing the best when more than one item is being offered to purchasers.

This reporting function enables an owner to access or receive aggregate information that includes sales result data from various ecommerce sites. The information is collected and available at one central location and represented, for example as tabular data or in graphical representations, in a potentially wide variety of segmented reports. For instance, if an owner sells multiple images related to the keyword “sunset,” the owner could receive a report that provides the top 10 selling images for all images having “sunset” as a keyword, across all the ecommerce web sites in one or more channels, or across only a subset of those ecommerce web sites.

The reporting function also provides the ability to aggregate raw sales/activity data from a plurality of ecommerce sites. It offers the ability to segment and represent this data on sub-elements of the original master electronic content file of sales meta data specific to the item. It offers the ability to segment and represent actual sales metrics. A specific example for a hypothetical seller of stock images is information on all “sunset” images (based on “keywords”/meta data) that are in the category “Urban/Cityscapes” (the categorization of those images/metadata), and then segmented by the type of purchase license (a sales metric indicating that the end buyer purchase the image in low-resolution for royalty use on a website, or in higher resolution for magazine publication, or yet what is commonly called an “extended license” for use printing postcard or calendars).

Another example varies sales information by marketing segmentation. For instance, purchaser data might be segmented by the different types of listings on a single ecommerce web. An example is an owner listing an item both as a “featured listing” (for a listing fee that might be at one rate) and on a “regular listing,” which might be at another rate. Another example varies sales information based on duration of availability of an item on an ecommerce web site.

The reporting function, therefore, makes possible: use of master electronic content file of sales meta data specific to the item; syndication meta data based on the owner-elected distribution rules to the channels or ecommerce web sites within a channel; traffic metadata, such as the number of times a given listing was visited, clicked, etc.); purchase metadata, such as licensing type, purchaser's demographics either physical (geographic, gender, etc.) or electronic (web browser type, Internet Service Provider, internet connection speed, etc.).

The reporting function may include one or more other steps, such as logging-in to a plurality of ecommerce web site in the channel; capturing data concerning a purchase of the item from each such ecommerce web site; merging the data with meta data available for the product in the master file; converting the aggregated data to a tabular or graphical representation segmented indifferently on purchase data or product meta data, such as product category or buyer geographical distribution reports; and, allowing the owner to access the reports on a server.

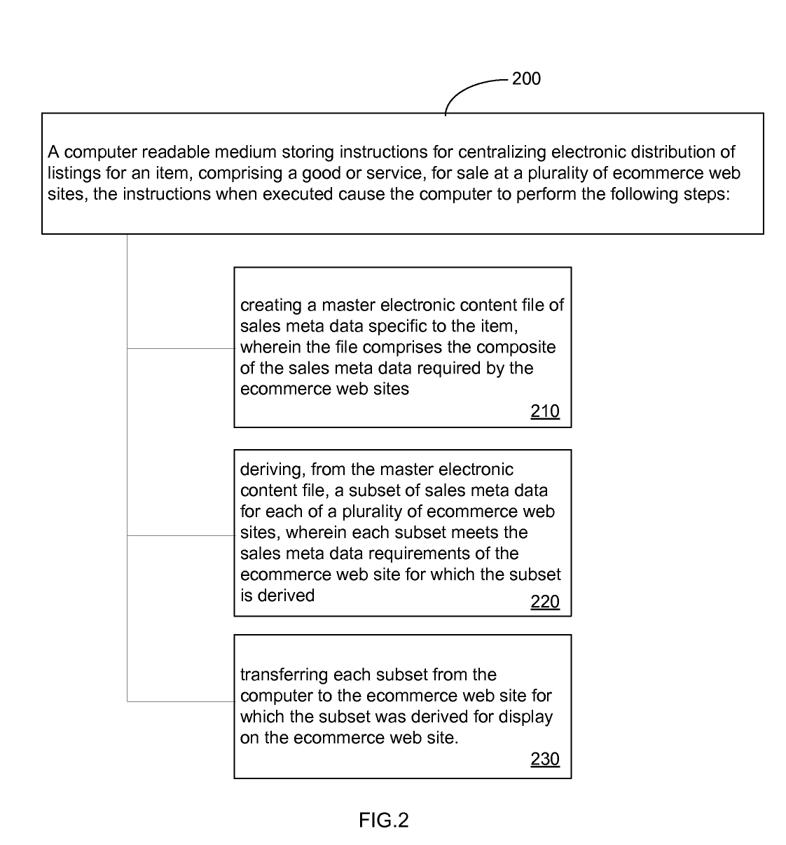

FIG. 2 illustrates a preferred embodiment of the system of the invention. The top box (200) indicates that the system of the invention is a computer readable medium storing instructions for centralizing electronic distribution of listings for an item, comprising a good or service, for sale at a plurality of ecommerce web sites, the instructions when executed cause the computer to perform various steps. The system is in part the software product that enables the steps of the method of the invention.

FIG. 2 shows that a preferred instruction performs a step of creating a master electronic content file of sales meta data specific to the item, wherein the file comprises the composite of the sales meta data required by the ecommerce web sites (210).

FIG. 2 shows that a preferred instruction performs a step of deriving, from the master electronic content file, a subset of sales meta data for each of a plurality of ecommerce web sites, wherein each subset meets the sales meta data requirements of the ecommerce web site for which the subset is derived (220).

FIG. 2 shows that a preferred instruction performs a step of transferring each subset from the computer to the ecommerce web site for which the subset was derived for display on the ecommerce web site (230).

The above-described embodiments including the drawings are examples of the invention and merely provide illustrations of the invention. Other embodiments will be obvious to those skilled in the art. Thus, the scope of the invention is determined by the appended claims and their legal equivalents rather than by the examples given.

### INDUSTRIAL APPLICABILITY

The invention has applicability to all industry involved in selling a good or service in commerce.

What is claimed is:

1. A centralized electronic distribution method aiding in listing an item, comprising a good or service, for sale at a plurality of ecommerce web sites, the method comprising the steps of:
engaging a channel to participate in receiving sales meta data on the item for display on each such ecommerce web site, wherein the channel comprises a plurality of ecommerce web sites;
contracting with an owner of an item to distribute sales meta data on the item to the channel;
creating a master electronic content file of sales meta data specific to the item and comprising the composite of the sales meta data required by the ecommerce web sites in the channel;
storing the master electronic content file on a server;
deriving, from the master electronic content file, a subset of sales meta data for each of a plurality of ecommerce web sites in the channel, wherein each subset meets the sales meta data requirements of the ecommerce web site in the channel for which the subset is derived; and,
transferring each subset from the server to the ecommerce web site in the channel for which the subset was derived for display on the web site.

2. The method of claim 1 wherein the master electronic content file comprises a category descriptor of the item; and, information identifying the owner.

3. The method of claim 1 further comprising the step of confirming the owner's authority to advertise with a plurality of ecommerce web sites within the channel, wherein confirming comprises an action selected from the group consisting of: establishing that the owner has an account with the channel; creating an account for the owner with the channel; and, creating a server-generated account with the channel on the owner's behalf.

4. The method of claim 1 further comprising the step of adding to the master electronic content file, authorization for the server to act on the owner's behalf with the channel.

5. The method of claim 1 further comprising the steps of storing on the server the item wherein the item comprises an electronic content file; and enabling download of the item from the server subsequent to its purchase through an ecommerce web site in the channel.

6. The method of claim 1 further comprising the steps of:
logging-in to an ecommerce web site in the channel;
capturing data concerning a purchaser of the item from the ecommerce web site; and,
communicating the data to the owner.

7. The method of claim 1 further comprising the steps of:
aggregating data on purchases of an item from a plurality of ecommerce sites in the channel; and,
segmenting and representing the data in a report.

8. The method of claim 7 further comprising a step of sending the report to the owner.

9. A computer readable medium storing instructions for centralizing electronic distribution of listings for an item, comprising a good or service, for sale at a plurality of ecommerce web sites, the instructions when executed cause the computer to perform the following steps:
creating a master electronic content file of sales meta data specific to the item, wherein the file comprises the composite of the sales meta data required by the ecommerce web sites;
deriving, from the master electronic content file, a subset of sales meta data for each of a plurality of ecommerce web sites, wherein each subset meets the sales meta data requirements of the ecommerce web site for which the subset is derived; and,
transferring each subset from the computer to the ecommerce web site for which the subset was derived for display on the ecommerce web site.
